(19) United States
(12) Patent Application Publication
(10) Pub. No.: US 2008/0153543 A1
(43) Pub. Date: Jun. 26, 2008

(54) PORTABLE ELECTRONIC DEVICE

(75) Inventors: Rhys Newman, Woodland Hills, CA (US); Tom Arbisi, Newbury Park, CA (US); Pascal Wever, Los Angeles, CA (US); Axel E. Meyer, Helsinki (FI); Roland Bird, Eindhoven (NL); Graham Hinde, Nuenen (NL); Roger Swales, Eindhoven (NL)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/614,881

(22) Filed: Dec. 21, 2006

(51) Int. Cl. H04M 1/00

(52) U.S. Cl. 455/556.1; 455/575.4

(57) ABSTRACT

Devices and methods are provided for providing a portable electronic device having a cable that functions as a carrying strap, a stylus, a data cable, and a power cable. Embodiments of the portable electronic device comprise at least one recess for storing a connector end of the cable, the stylus, and a wireless headset when such components are not in use. Embodiments of the present invention also provide an electrical connector at the end of a cable that is convertible between a stylus and an electrical connector.

### FIELD OF THE INVENTION

Embodiments of the invention relate generally to a stylus, electrical connector, and carrying strap combination for a swivel-storage portable electronic device.

### BACKGROUND OF THE INVENTION

Increasingly, portable electronic devices are configured to provide a variety of functions to the user. For example, modern portable devices may combine the functions of a cellular phone, a persona digital assistant (PDA), a camera, a radio, a web browser, a gaming system, and the like into a single mobile terminal. Furthermore, such portable electronic devices can often hold very large amounts of data, some of which the user employs on a daily basis. Not only is the user often linking the portable device to the user's computer to do such things as upload pictures to the computer or download music files to the portable device, but a user may often want to share data with others when the user is out and about. As a result, a user often requires use of a cable for transmitting data to and from the user's portable electronic device to other electronic devices. However, it can be inconvenient for a user to carry a data cable wherever the user goes since it is cumbersome and would likely be misplaced.

Furthermore, portable electronic devices have rechargeable batteries and must be recharged fairly regularly. This is especially true if the portable device is used regularly by the user for performing power intensive tasks. As with the data cable, it is usually not convenient for the user to carry around a power cable for the portable device.

Along with the increased functionality, today's portable devices often have a variety of accessory components that the user can use with the portable device to enhance the user's experience. One common accessory component is the headset. In particular, wireless headsets having a speaker and a microphone have become popular accessories for mobile telephones. Headsets are also desired for such things as listening to music and other audio or for dictating to a recorder. Although the headsets are typically very small, fitting over a portion of the user's ear, they can still be inconvenient to carry. Often the small size of the headset makes it easy to misplace the headset, which can be very costly to the user since a good headset can be fairly costly. Headsets can also be easily damaged since the typical small size does not allow for much protection of the electronics contained therein.

Another common accessory for portable electronic devices is a stylus. With touch screen displays becoming much more common and with the increased resolution of such displays, a user can communicate a lot of information to the portable electronic device in a short amount of time using a stylus in combination with the touch screen display. Often the small size of the display on a portable device does not make it convenient for the user to enter input using a finger. Although the portable electronic devices that make use of a stylus often have a place to store the stylus, styluses are still often misplaced since they are so small and are generally not permanently attached to the portable device.

Many users also desire to have a wrist strap, a neck strap, or some other carrying strap attached to the portable electronic device to help carry the device. A carrying strap can be very important since modern portable electronic devices are not only expensive, but also may contain a large amount of often irreplaceable data that is important to the user. Misplacing or dropping a mobile terminal can be very costly both in terms of money and lost data.

Thus, it would be advantageous if a solution was developed that allowed a user to more easily carry around a portable electronic device with the device's data cable, power cable, headset, stylus, wrist strap, and other components and accessories. Preferably, the solution would allow the user carry around all these devices and accessories together in a space not much larger than the portable device itself.

### BRIEF SUMMARY OF THE INVENTION

Embodiments of the present invention provide a portable electronic device having a first housing portion, a second housing portion, and an accessory component. The first housing portion and the second housing portion are movably coupled such that the first housing portion can be moved relative to the second housing portion from a closed configuration to an opened configuration. The opened configuration exposes a recess in the first housing portion. The recess is structured to removably receive the accessory component when the first and second housing portions are in the opened configuration. The first and second housing portions are structured such that the accessory device is retainable in the recess when the first and second housing portions are in the closed configuration.

The accessory device may include an electrical connector for electrically coupling the portable electronic device to another electronic device. The accessory device may further include a cable having a first end extending from the electrical connector and a second end extending from one of the first and second housing portions of the portable electronic device. The recess may be structured to receive the electrical connector, and the electrical connector may be retained in the recess when the first and second housing portions are in the closed configuration. When the electrical connector is retained in the recess, the cable may be usable as a carrying strap for the portable electronic device.

In one embodiment, the portable electronic device further comprises a touch screen display and the accessory device comprises a cable where the electrical connector is structured to be convertible between an electrical connector and a stylus for use with the touch screen display. For example, the electrical connector may comprise a stylus portion that covers the end of the connector when the electrical connector is configured to be used as a stylus. The stylus portion may be movable to uncover the end of the electrical connector so that the electrical connector is configured to be used to electrically couple the portable electronic device to another electronic device.

In one embodiment, the electrical connector comprises a Universal Serial Bus type connector. Both the first and the second housing portions may contain electronics other than accessory device electronics. One of the first and second housing portions may include a camera. In one embodiment, the portable electronic device comprises a mobile telephone.

In one embodiment, the portable electronic device may comprise an accessory device comprising a headset having a speaker. One of the first and second housing portions may comprise a recess for removably receiving and retaining a wireless headset. The headset may comprise a wireless headset and the portable electronic device may be configured such that a battery in the wireless headset is chargeable by the portable electronic device when the headset is disposed in the recess. When the first and the second housing portions are in the closed configuration and when the headset is retained in the recess, portions of the first and second housing portions and a portion of the headset may form an external surface of the portable electronic device.

In one embodiment, the first housing portion and the second housing portion are pivotably connected. The accessory device may comprise a strap having a first end having a stylus and a second end extending from one of the first and second housing portions. The recess may be structured to receive the stylus, and the stylus may be retained in the recess when the first and second housing portions are in the closed configuration such that the strap is usable as a carrying strap for the portable electronic device.

Embodiments of the present invention also provide a portable electronic device comprising a cable for electrically coupling the portable electronic device to another electronic device. The cable has a first end physically and electrically connected to the portable electronic device. The cable has a second end including both a stylus and a connector for electrically coupling the cable to the other electronic device.

In one embodiment, the second end has a connector for electrically coupling the cable to the other electronic device, and a generally pointed stylus portion for use as a stylus. The stylus portion of the second end may be structured to be moveable between a first position where the stylus portion covers the connector, and a second position where the connector is exposed. The stylus portion may define a recess for receiving at least a portion of the connector when the stylus portion is in the first position. The stylus portion may be hingedly connected to the second end of the cable such that the stylus portion is movable from the first position to the second position while remaining connected to the second end of the cable when in both the first and second positions.

The second end of the cable may further be structured so that the stylus portion is moveable from the first position to the second position by sliding the stylus portion along an axis defined by the connector and in a direction generally away from the connector in order to remove the connector from the recess in the stylus portion, and rotating the stylus portion in order to uncover the connector. The portion of the second end of the cable containing the connector may comprise two pins oppositely disposed on each side of the connector. The stylus portion may comprise two oppositely disposed tracks that are structured to engage the two pins and allow the stylus portion to slide and rotate relative to the connector.

In one embodiment, the second end of the cable is removably attachable to a portion of the portable electronic device so that the cable generally forms a loop structured to be used as a carrying strap. The cable may be configured to be connectable to another electronic device for transferring data and power between the portable electronic device and the other electronic device. The connector may include a Universal Serial Bus type connector.

The portable electronic device may further comprise a touch screen display, and the stylus may be configured to enter data by touching the display or by moving the stylus over the display.

Embodiments of the present invention also provide a method of using an electronic cable as a carrying strap for a portable electronic device. The cable has a first end extending from the portable electronic device and a second end having an electrical connector. The method comprises (i) moving a first housing portion of the portable electronic device relative to a second housing portion of the portable electronic device from a first position to a second position exposing a recess in the first housing portion; (ii) placing the electrical connector into the recess; and (iii) rotating the first housing portion back to the first position.

The method may further include: (iv) moving the first housing portion relative to the second housing portion from the first position to the second position exposing the electrical connector in the first housing portion; (v) removing the electrical connector from the recess; and (vi) coupling the electrical connector to a corresponding connector in another electronic device.

The method may further include exposing the electrical connector by moving a stylus portion. The moving step of the method may further comprise pivoting the first housing portion relative to the second housing portion about a pivot point.

Embodiments of the present invention also provide a method of converting a stylus to an electrical connector, the stylus comprising a stylus portion coupled to an end of an electrical cable and covering an end of the electrical connector. The method includes rotating the stylus portion to one side of the electrical connector such that the end of the electrical connector is capable of connecting to a compatible connector. The method may further include, prior to the rotating of the stylus portion, sliding the stylus portion in a direction away from the end of the cable, thereby, exposing the end of the electrical connector. The method may also include coupling the electrical connector to a corresponding connector in another electronic device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a portable electronic device in accordance with one embodiment of the present invention;

FIGS. 2A and 2B illustrate perspective views of the exterior of a portable electronic device according to one embodiment of the present invention;

FIGS. 3A-3D illustrate perspective views of a portable electronic device in various stages of moving from a closed position to an opened position in accordance with one embodiment of the present invention; FIGS. 3A-3D also illustrate how the portable electronic device may be structured to receive a stylus, a connector, and a headset in accordance with one embodiment of the present invention;

FIGS. 4A-4D illustrate perspective views of one end of a cable of the portable electronic device and show how the end of the cable may be convertible between a stylus configuration and a connector configuration in accordance with one embodiment of the present invention;

FIG. 5 illustrates a section view of the end of the cable depicted in FIG. 4B in accordance with one embodiment of the present invention; and

FIG. 6 illustrates a perspective view of the end of the cable with the stylus portion removed in order to the system for connecting the stylus portion to the connector portion in accordance with one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

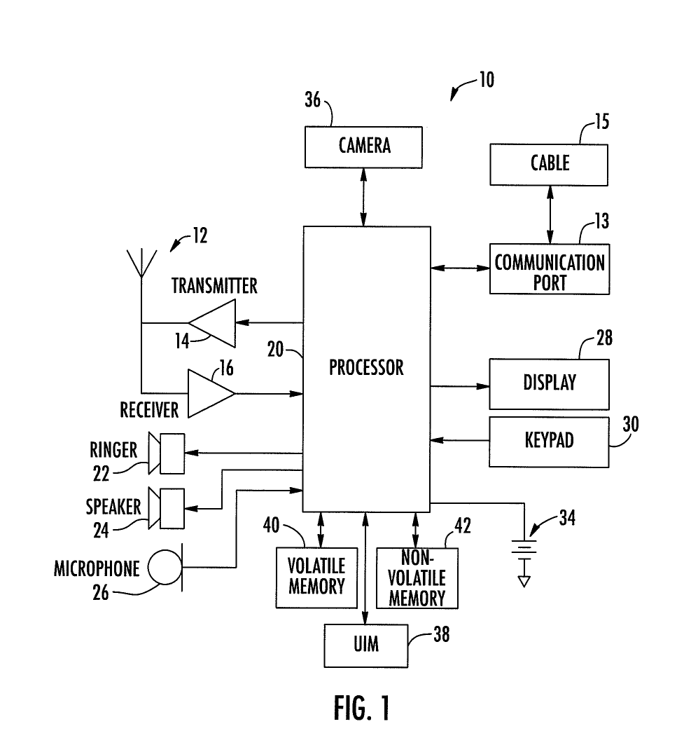

FIG. 1 illustrates a block diagram of a portable electronic device 10, according to one embodiment of the present invention. Although FIG. 1 illustrates a mobile telephone as the portable electronic device, it should be understood that a mobile telephone is merely illustrative of one type of portable electronic device that could be used with embodiments of the present invention. While several embodiments of the portable electronic device 10 are illustrated and will be hereinafter described for purposes of example, other types of portable electronic devices, such as digital cameras, portable digital assistants (PDAs), pagers, mobile televisions or video players, mobile computers, laptop computers, mp3 players, satellite radio units, mobile video game consoles, and other types of systems that manipulate and/or store data files, can readily employ embodiments of the present invention. Such devices may or may not be mobile.

The portable electronic device 10 includes a communication interface comprising an antenna 12 in operable communication with a transmitter 14 and a receiver 16. The portable electronic device 10 further includes a processor 20 or other processing element that provides signals to and receives signals from the transmitter 14 and receiver 16, respectively. The signals include signaling information in accordance with the air interface standard of the applicable cellular system, and also user speech and/or user generated data. In this regard, the portable electronic device 10 is capable of operating with one or more air interface standards, communication protocols, modulation types, and access types. By way of illustration, the portable electronic device 10 is capable of operating in accordance with any of a number of first, second and/or third-generation communication protocols or the like. For example, the portable electronic device 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

The portable electronic device 10 also includes a communication interface comprising a communication port 13 configured to be permanently or removably connected to a cable 15 that can be used to connect the portable electronic device 10 to other electronic devices. The processor 20 may provide signals to and receive signals from the communication port 13. The portable electronic device 10 may be configured to use the communication port 13 and the cable 15 to communicate with other electronic devices. The portable electronic device 10 and the cable 15 may be structured so that data and/or power may be communicated between the portable electronic device 10 and the other electronic device. For example, in one embodiment, the cable 15 comprises a Universal Serial Bus (USB) cable having data wires, a power wire, and a ground wire. Power received through the cable 15 may be used by the portable electronic device 10 to power various components of the device and/or charge a battery 34.

It is understood that the processor 20 includes circuitry required for implementing audio and logic functions of the portable electronic device 10. For example, the processor 20 may be comprised of a digital signal processor device, a microprocessor device, and various analog to digital converters, digital to analog converters, and other support circuits. Control and signal processing functions of the portable electronic device 10 are allocated between these devices according to their respective capabilities. The processor 20 thus may also include the functionality to convolutionally encode and interleave message and data prior to modulation and transmission. The processor 20 can additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the portable electronic device 10 to transmit and receive Web content, such as location-based content, according to a Wireless Application Protocol (WAP), for example.

The portable electronic device 10 also comprises a user interface including an output device such as a conventional earphone or speaker 24, a ringer 22, a microphone 26, a display 28, and a user input interface, all of which are coupled to the processor 20. The user input interface, which allows the portable electronic device 10 to receive data, may include any of a number of devices allowing the portable electronic device 10 to receive data, such as a keypad 30, a touch display (not shown) or other input device. In embodiments including the keypad 30, the keypad 30 may include the conventional numeric (0-9) and related keys (#, *), and other keys used for operating the portable electronic device 10. Alternatively, the keypad 30 may include a conventional QWERTY keypad. The portable electronic device 10 further includes a battery 34, such as a vibrating battery pack, for powering various circuits that are required to operate the portable electronic device 10, as well as optionally providing mechanical vibration as a detectable output.

In one embodiment, the portable electronic device 10 includes a headset (not shown). The headset may comprise a speaker and/or a microphone that may be used in addition to or as an alternative to speaker 24 and microphone 26. The headset may be wired to the portable electronic device 10 or the headset may be configured to wirelessly communicate with the portable electronic device 10 through one of the portable electronic device's communication interfaces. In one embodiment, the portable electronic device may use Bluetooth® wireless technology to communicate with the wireless headset. Bluetooth® is an open radio-frequency standard that enables cable-free voice and data communication between devices through short-range two-way radio (in the radio frequency range of 2.45 gigahertz).

In an exemplary embodiment, the portable electronic device 10 includes a camera 36 in communication with the processor 20. The camera 36 may be any means for capturing an image for storage, display or transmission. For example, the camera 36 may include a digital camera capable of forming a digital image file from a captured image. As such, the camera 36 includes all hardware, such as a lens or other optical device, and software necessary for creating a digital image file from a captured image. Alternatively, the camera 36 may include only the hardware needed to view an image, while a memory device of the portable electronic device 10 stores instructions for execution by the processor 20 in the form of software necessary to create a digital image file from a captured image. In an exemplary embodiment, the camera 36 may further include a processing element such as a co-processor which assists the processor 20 in processing image data and an encoder and/or decoder for compressing and/or decompressing image data. The encoder and/or decoder may encode and/or decode according to a JPEG or an MPEG standard format.

The portable electronic device 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the portable electronic device 10 may be equipped with memory. For example, the portable electronic device 10 may include volatile memory 40, such as volatile Random Access Memory (RAM) including a cache area for the temporary storage of data. The portable electronic device 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the portable electronic device 10 to implement the functions of the portable electronic device 10. For example, the memories can include an identifier, such as an international mobile equipment identification (IMEI) code, capable of uniquely identifying the portable electronic device 10.

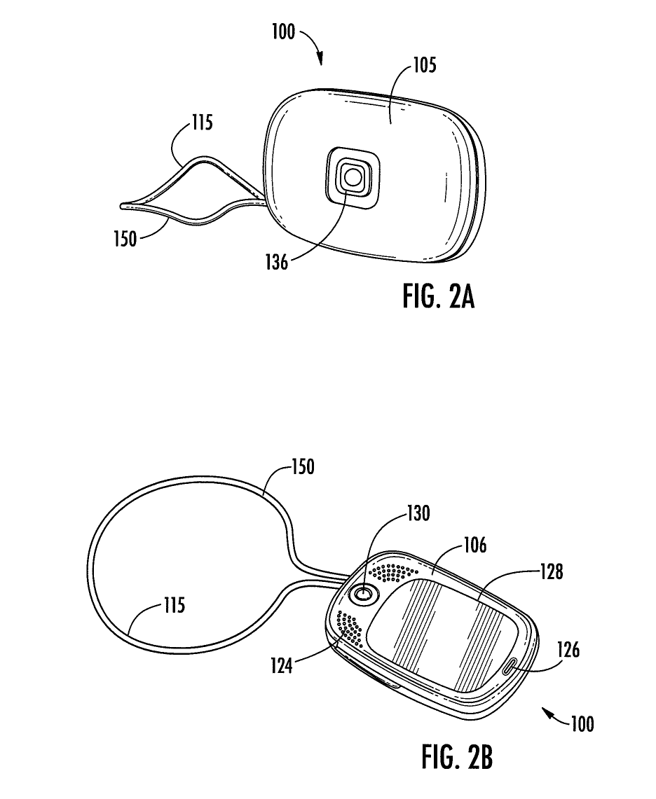

FIG. 2A illustrates a perspective view of a first side 105 of a portable electronic device 100 according to one exemplary embodiment of the present invention. FIG. 2B illustrates a perspective view of a second side 106 of the portable electronic device 100 according to one exemplary embodiment of the present invention. The portable electronic device 100 of FIGS. 2A and 2B may include some, but not necessarily all of the components of the portable electronic device 10 described above in relation to FIG. 1. As depicted in FIG. 2A, the first side 105 of the portable electronic device 100 includes a camera 136. As depicted in FIG. 2B, the second side 106 of portable electronic device 100 includes a microphone 126, one or more speakers 124, a touch screen display 128, and a key 130. The portable electronic device 100 also includes a strap 150, such as a wrist strap, a neck strap, or the like, extending from one end of the portable electronic device 100. As will be described in greater detail below, strap 150 comprises a cable 115, such as a USB compatible cable or the like. Of course, other combinations, orientations, and configurations of device components are also possible, as will be obvious to one of ordinary skill in the art in view of this disclosure.

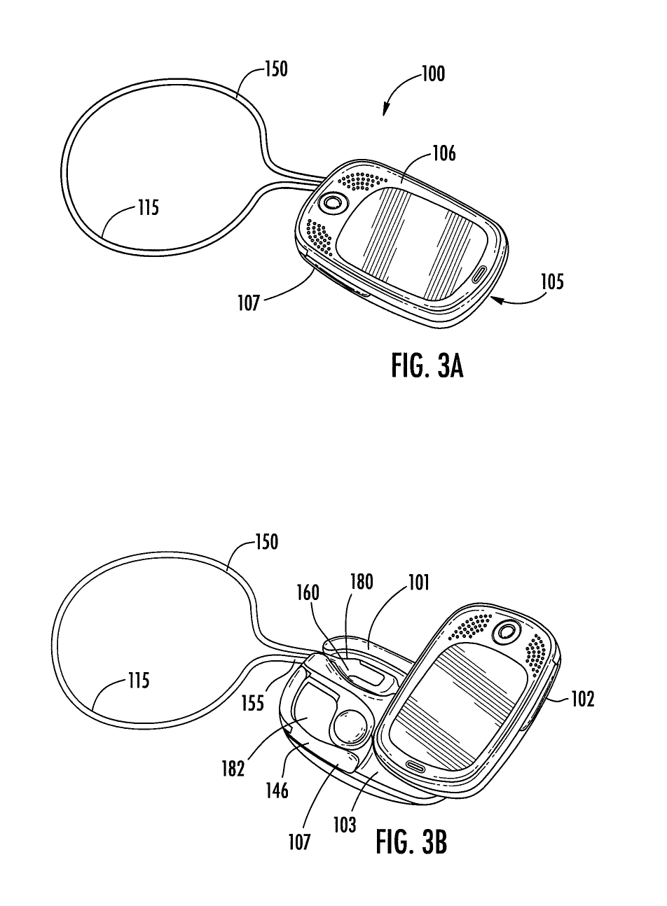

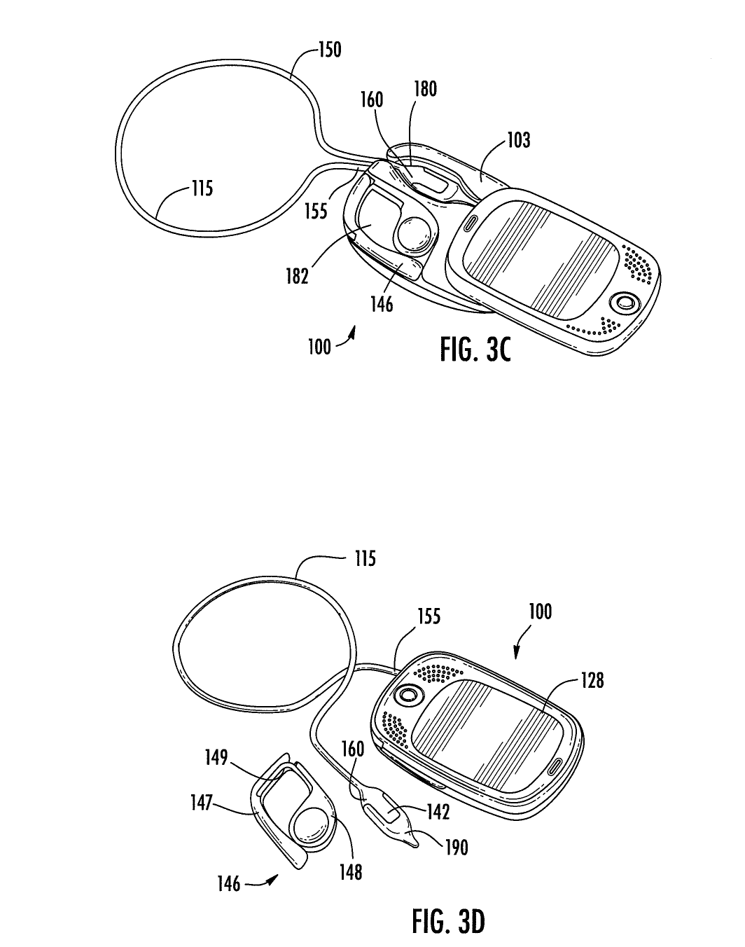

FIGS. 3A-3D illustrate perspective views of portable electronic device 100 and various features and components of the portable electronic device 100 according to one embodiment of the present invention. More particularly, as illustrated in FIGS. 3A-3D, portable electronic device 100 includes a first housing portion 101 and a second housing portion 102. The first housing portion 101 and the second housing portion 102 are structured to be moveable with respect to each other. In the embodiment depicted by FIGS. 3A-3D, the first housing portions 101 and 102 are pivotably connected by a hinge (not shown) so that the second housing portion 102 can pivot about the hinge relative to the first housing portion 101. The hinge may comprise a variety of structures known in the art that would permit the depicted pivotable movement of the housing sections.

FIG. 3A illustrates the portable electronic device 100 in a closed configuration. FIG. 3B illustrates the portable electronic device 100 in a partially opened configuration where the second housing portion 102 is rotated approximately 90° about the pivot point relative to the first housing portion 101. FIG. 3C illustrates the portable electronic device 100 in a fully opened configuration where the second housing portion 102 is rotated approximately 180° about the hinge relative to the first housing section 101. When the portable electronic device is in an opened configuration, such as in FIGS. 3B and 3C, at least a portion of the inner sides of the first and second housing portions are exposed to the user. For example, in FIGS. 3B and 3C, a portion of the inner side 103 of the first housing portion 101 can be seen. As illustrated in FIGS. 3A-3C, in the illustrated embodiment, the hinge (not shown), or at least the axis of rotation of the hinge, is offset from the center of the portable electronic device 100 and is positioned closer to an end of the portable electronic device 100 so that, when the portable electronic device 100 is in the fully opened configuration, a greater portion of the inner sides of the housing portions may be exposed to the user. In the illustrated embodiment, the hinge is positioned closer to the end of the portable electronic device 100 opposite the end that the strap 150 extends from.

In the depicted embodiment, the portable electronic device 100 is divided into the two housing portions 101 and 102 by dividing the portable electronic device along a plane between and generally parallel to the first side 105 and the second side 106. In this regard, the first housing portion 101 comprises the first side 105 of the portable electronic device 100 and the second housing portion 102 comprises the second side 106 of the portable electronic device 100. As such, in the illustrated embodiment, the housing portions 101 and 102 each include electronics used for operating at least the electrical components housed by the respective housing portion. So that the electronics from the first housing portion 101 may communicate with the electronics in the second housing portion 102, the hinge is configured to allow electrical communication between the electronics in the first housing portion 101 and the second housing portion 102. For example, in one embodiment, the hinge may permit one or more cables to pass through the hinge proximate to the axis of rotation. In other embodiments, the hinge may be configured to have conductive elements that are movable relative to each other but maintain constant electrical contact throughout the movement.

In other embodiments of the present invention, the housing portions may be configured differently. For example, the portable electronic device may be divided in other ways and may be divided into more than two housing portions. Furthermore, in some embodiments, one or more of the housing portions do not contain electronics. Although the Figures and embodiments described herein illustrate two housing portions pivotally connected, in other embodiments two or more housing portions may be movably connected in other manners, such as by being hingedly connected by a door-like hinge or by being slidably connected using track-like devices.

As illustrated in FIGS. 3B and 3C, the first housing portion 101 of the portable electronic device 100 includes one or more recesses for removably receiving and storing one or more accessory components of the portable electronic device. For example, in the illustrated embodiment of the present invention, the portable electronic device 100 includes a wireless headset 146. The wireless headset 146 includes an auxiliary speaker and microphone, a wireless communication interface, a processor, and a battery. The wireless headset 146 illustrated is comprised of a first portion 147 and a second portion 148 joined by an elastomeric material 149. The elastomeric material 149 forms a living hinge that allows the first and second portions of the headset to be positioned on opposite sides of the user's ear when the headset is in use.

The inner side 105 of the first housing portion 101 includes a headset receiving area 182 for removably receiving the headset 146. However, the headset receiving area could be defined by the inner side of the second housing portion if desired. The headset receiving area 182 is deep enough to receive the headset 146 and allow the second housing portion 102 to rotate back over the first housing portion 101. In this way, when not being used, the headset 146 may be stored inside the portable electronic device 100 where it is more easily carried and better protected. The headset receiving area 182 may completely surround the perimeter of the wireless headset 146 or, as depicted in FIGS. 3A-3D, the recess may be configured so that at least a portion of the wireless headset 146, e.g., the first portion 147, forms a portion 107 of the external surface of the portable electronic device 100 when the wireless headset is stored in the headset receiving area 182 and the portable electronic device 100 is in the closed configuration. The headset receiving area 182 may loosely receive the headset 146 or may be structured so that the headset 146 snugly fits into the receiving area 182. In some embodiments, the recess may be further configured to include one or more protrusions or devices for removably holding the headset 146 in the headset receiving area 182.

In one embodiment of the invention, the portable electronic device 100 is configured so that the battery in the wireless headset 146 can be charged when the headset 146 is stored in the headset receiving area 182. The battery of the wireless headset 146 may be charged using power from the portable electronic device's main battery and/or from power received through cable 115 or some other power cable. The battery in the wireless headset 146 may be charged in a variety of ways in different embodiments of the present invention. For example, the wireless headset may comprise one or more conductive elements that contact corresponding conductive elements in the headset receiving area 182. The conductive elements in the headset receiving area 182 may be coupled to the portable electronic device's main battery and/or to a power wire in cable 115 or some other power cable. In another embodiment, the wireless headset battery is charged through a contactless charging method, such as induction charging.

As mentioned above, strap 150 comprises a cable 115. The cable 115 has a first end 155 and a second end 160. In the illustrated embodiment, the first end 155 extends from and is permanently connected to the first housing portion 101. More particularly, the cable 115 extends through an opening in the first housing portion 101 and connects to the electronics in the portable electronic device 100. In another embodiment, the first end 155 of the cable 115 may be removably attached to the first housing portion 101. In such an embodiment, if the cable 115 is to also perform the function of a carrying strap 150, then the removable connection between the first end 155 of the cable 115 and the housing portion 101 is advantageously configured such that the first end 155 of the cable 115 would not become disconnected when the cable 115 is being used as a strap 150.

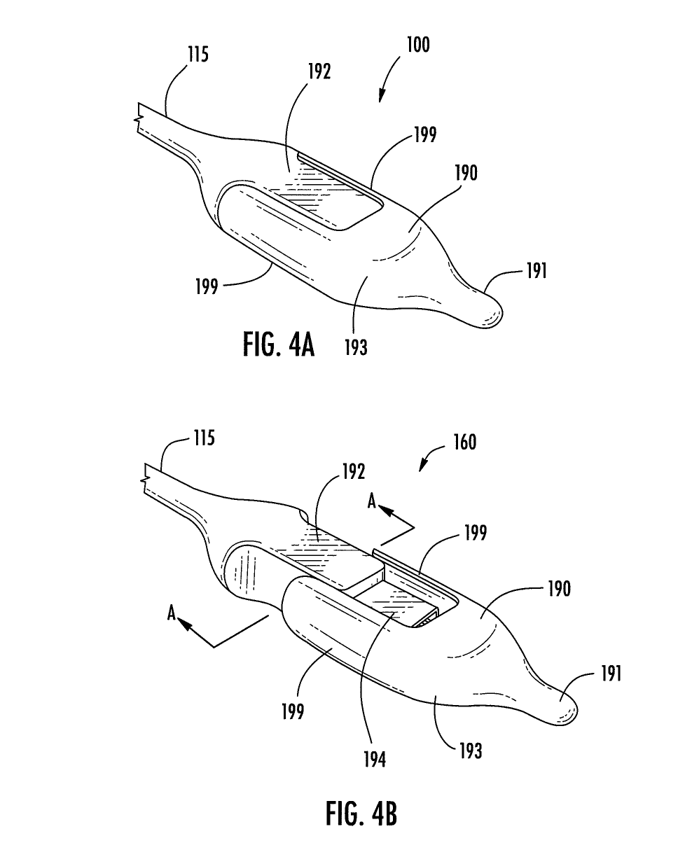

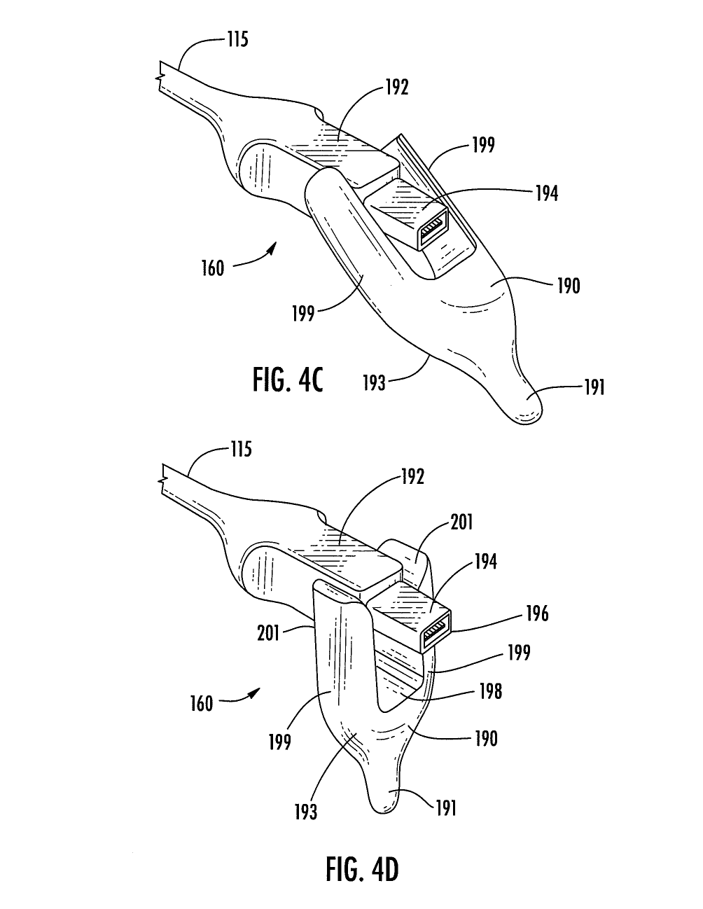

The second end 160 of the cable comprises an electrical connector 192 for electrically connecting to a compatible connector on another electronic device. The cable 115 may be any number of cable types for transferring data and/or power to and from another electronic device. For example, the cable 115 may be a USB type cable that can be used for both transmitting data and power between the portable electronic device and another compatible electronic device, such as a computer, another portable electronic device, or a power source. As will be described in greater detail below with respect to FIGS. 4A-4D, in the illustrated embodiment, the second end 160 is structured to be convertible from an electrical connector to a stylus. When configured to be used as a stylus, the user of the portable electronic device 100 can use the stylus 190 attached to the end 160 of the cable 115 in combination with the touch screen display 128 to enter data into the portable electronic device 100.

Referring again to FIGS. 3B and 3C, the inner side of the first housing section 101 includes a second end receiving area 180 for receiving the second end 160 of the cable 115. As described above, the second end 160 of the cable 115 may comprise an electrical connector 192 and/or a stylus 190. The recess in the second end receiving area 180 is structured to be deep enough to receive the second end 160 of the cable 115 and allow the second housing portion 102 to rotate back over the first housing portion 101. In this way, when not being used, the second end 160 of the cable 115 may be stored inside the portable electronic device 100 where it is more easily carried and better protected. Furthermore, as illustrated in FIG. 3A, when the portable electronic device 100 is in the closed configuration with the second end 160 of the cable 115 retained within the second end receiving area 180, the cable 115 may be used as a wrist strap 150 or other carrying strap for the portable electronic device 100.

The first housing portion 101 is structured to have openings to permit the cable 115 to pass through when the second end 160 of the cable 115 is retained in the second end retaining area 180 and the portable electronic device 100 is in the closed configuration. Since the second end 160 of the cable 115 is larger in cross section dimensions then the cable 115, the second end 160 of the cable 115 is retained in the second end retaining area 180 when the second housing portion 102 is positioned over the second end retaining area 180 in the closed configuration. The second end receiving area 180 may loosely receive the second end 160 of the cable 115 or may be structured so that the second end 160 snugly fits into the receiving area 180, as shown in FIGS. 3B and 3C. In some embodiments, the recess may further be configured to include one or more protrusions or devices for removably holding the second end 160 of the cable 115 in the second end receiving area 180.

FIG. 3D illustrates the portable electronic device 100 with the first and second housing portions 101 and 102 in the closed configuration, but with the wireless headset 146 and the second of end 160 of the cable 115 (shown in the stylus configuration, but including the electrical connector 192 and the stylus 190) removed from the recesses in the first housing portion 101. As can be seen in FIG. 3D, the cable is long enough to permit the user to easily use the stylus 190 on the end 160 of the cable 115 with the touch screen display 128. By being attached to the cable 115, the stylus 190 is tethered to the portable electronic device 100 and will not be easily lost.

Although the illustrated embodiment shows a strap 150 that includes a cable 115, an electrical connector 192, and a stylus 190, other embodiments of the present invention may comprises a strap 150 with a stylus 190, without the cable and the connector. Similarly, in some embodiments of the present invention, the strap 150 comprises a cable 115 and the associated electrical connector 192, but not the stylus 190.

Referring now to FIGS. 4A-4D, the Figures illustrate perspective views of the second end 160 of cable 115 of the portable electronic device 100 and show how the end 160 of the cable 115 may be structured to be convertible between a stylus configuration and a connector configuration in accordance with one embodiment of the present invention. FIG. 4A depicts the end 160 of the cable 115 in the stylus configuration where the stylus portion 190 covers electrical connector 194. As the Figures illustrate, the cable 115 expands to form a connector portion 192 that is integrally formed with the cable, although the connector portion 192 need not be integrally formed with the cable 115 and can, instead, be mounted to the end of the cable 115. As can be seen in FIGS. 4B to 4D, the connector portion 192 includes an electrical connector 194. The connector 194 comprises pins or other electrical contacts 196 for electrically coupling the end 160 of the cable to a corresponding connector in another electronic device. The illustrated connector 194 comprises a mini USB-type connector. The mini-USB connector is small enough so that it may fit within a recess in the portable electronic device 100 as described above. The mini-USB cable comprises both data pins and a power pin so that the cable 115 can be used for both data and power transmission. Of course, other types of cables and electrical connectors may be used in other embodiments of the present invention. Furthermore, although the Figures show the connector and cable to be comprised of electrical conductors, the connector and cable could be optical waveguides in other embodiments of the present invention.

When in the stylus configuration shown in FIG. 4A, a stylus portion 190 covers the connector 194. The stylus portion 190 of the illustrated embodiment comprises two arms 199 oppositely disposed on either side of the connector portion 192. Extending from the arms 199, a tapered region 193 tapers the stylus portion 190 down to a tip portion 191. Preferably, the stylus portion 190, or at least the tip 191 of the stylus portion 190, is comprised of a material that allows the tip of the stylus to slide smoothly over the touch screen display without scratching the touch screen display. For example, the tip portion 191 may be comprised of a smooth polymeric or metallic material and may have a rounded tip.

As depicted in FIG. 4D, the tapered region 193 of the stylus portion 190 comprises a connector recess 198. The connector recess 198 is structured such that it can receive the connector 194. When the end 160 of the cable 115 is in the stylus configuration, the stylus portion 190 covers the connector 194 by receiving the connector 194 into the connector recess 198. In one embodiment of the present invention, the end 160 of the cable 115 can be converted from the stylus configuration shown in FIG. 4A to a connector configuration where the connector is capable of connecting to a corresponding connector, by removing the stylus portion entirely from the end 160 of the cable 115. In such an embodiment, the stylus portion 190 may be connected to the end connector portion 192 by clips or by a tight fit between the connector 194 and the connector recess 198 and/or a tight fit between the arms 199 and the connector portion 192. In such an embodiment, it may be easy for the user of the portable electronic device to misplace the stylus portion when using the end of the cable 115 as an electrical connector. As such, the second end receiving area 180 may be used to hold the stylus portion 190 when not connected to the end 160 of the cable 115.

In another embodiment, such as the embodiment illustrated in FIGS. 4A-4D, the stylus portion 190 is movably connected to the connector portion 192 so that the stylus portion 190 can be moved from a position covering the connector 194 to a position where the connector 194 is exposed, while keeping the stylus portion 190 connected to the end 160 of the cable 115. For example, as illustrated in FIGS. 4A-4D, the end 160 of the cable 115 may be structured such that the stylus portion 190 can be slid away from the connector portion 192 in a direction generally along an axis defined by the connector 194. Once the connector 194 is completely removed from the connector recess 198, as shown in FIG. 4B, the stylus portion 190 may be rotated to one side of the connector 194 so that the pins or other contacts 196 are exposed, as shown in FIGS. 4C and 4D.

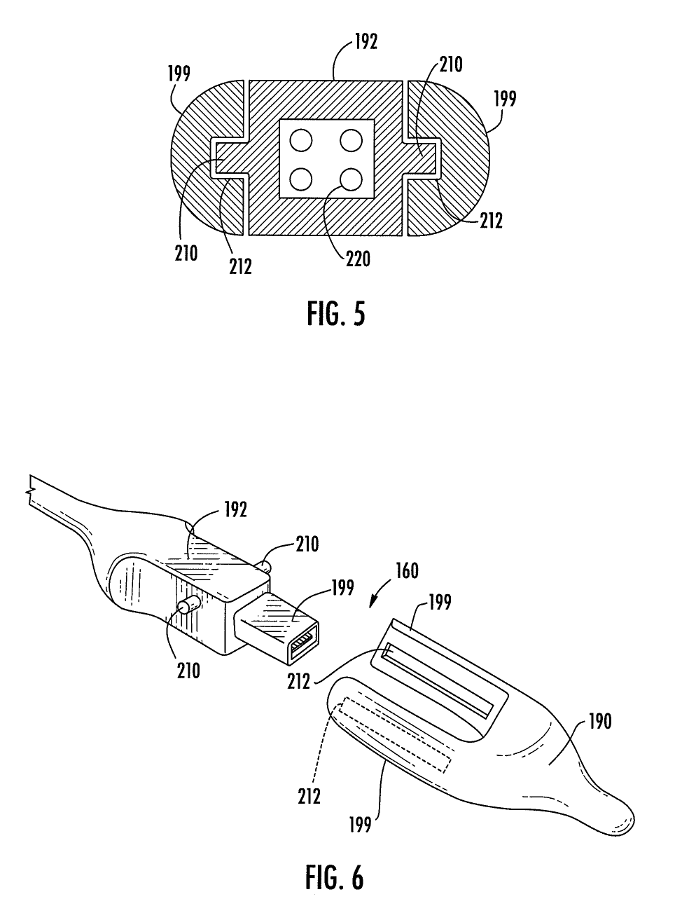

FIGS. 5 and 6 illustrated the connection between the stylus portion 190 and the connector portion 192 in accordance with one embodiment of the present invention. In particular, the FIG. 5 depicts a section view of the end 160 of the cable 115 of FIG. 4B along section line AA. The connector portion 192 comprises a cylindrical pin 210 located on each side of the connector portion 192 under the arms 199 of the stylus portion 190. Each pin 210 engages a corresponding track 212 located on the inside of the each arm 199 of the stylus portion 190. The tracks 212 extend along a portion of the length of each arm 199 and are configured such that the pins 210 may both slide and rotate in the tracks 212. In this way, the stylus portion 190 may be first slid from the position illustrated in FIG. 4A to the position illustrated in FIG. 4B by sliding the tracks 212 over the pins 210. The stylus portion 190 may then be rotated from the position shown in FIG. 4B to the positions shown in FIGS. 4C and 4D by rotating the tracks 212 around the pins 210. In other embodiments, the pins may be on the arms 199 of the stylus portion 190 and the tracks may be located in the connector portion 192. In still other embodiments, other structures for moving the stylus portion 190 from a position covering the connector 194 to a position where the connector 194 is exposed can be used, as will be obvious to a person having ordinary skill in the art in light of this disclosure.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A portable electronic device comprising:
a first housing portion;
a second housing portion; and
an accessory component;
wherein the first housing portion and the second housing portion are movably coupled such that the first housing portion can be moved relative to the second housing portion from a closed configuration to an opened configuration, wherein the opened configuration exposes a recess in the first housing portion, wherein the recess is structured to removably receive the accessory component when the first and second housing portions are in the opened configuration, and wherein the first and second housing portions are structured such that the accessory device is retainable in the recess when the first and second housing portions are in the closed configuration.

2. The portable electronic device of claim 1, wherein the accessory device comprises an electrical connector for electrically coupling the portable electronic device to another electronic device.

3. The portable electronic device of claim 2, wherein the accessory device further comprises a cable having a first end extending from the electrical connector and a second end extending from one of the first and second housing portions, wherein the recess is structured to receive the electrical connector, and wherein the electrical connector is retained in the recess when the first and second housing portions are in the closed configuration such that the cable is usable as a carrying strap for the portable electronic device.

4. The portable electronic device of claim 2, further comprising a touch screen display;
wherein the accessory device further comprises a cable having a first end extending from the electrical connector and a second end extending from one of the first and the second housing portions, wherein the electrical connector is structured to be convertible between an electrical connector and a stylus for use with the touch screen display.

5. The portable electronic device of claim 4, wherein the electrical connector comprises a stylus portion that covers the end of the connector when the electrical connector is configured to be used as a stylus, and wherein the stylus portion is movable to uncover the end of the electrical connector so that the electrical connector is configured to be used to electrically couple the portable electronic device to another electronic device.

6. The portable electronic device of claim 2, wherein the electrical connector comprises a Universal Serial Bus type connector.

7. The portable electronic device of claim 1, wherein portable electronic device electronics other than the electronics in the accessory device are contained within both the first and the second housing portions.

8. The portable electronic device of claim 1, wherein one of the first and second housing portions comprises a camera.

9. The portable electronic device of claim 1, wherein the portable electronic device comprises a mobile telephone.

10. The portable electronic device of claim 1, wherein the accessory device comprises a headset having a speaker.

11. The portable electronic device of claim 10, wherein the headset comprises a wireless headset and wherein the portable electronic device is configured such that a battery in the wireless headset is chargeable by the portable electronic device when the headset is disposed in the recess.

12. The portable electronic device of claim 10, wherein when the first and the second housing portions are in the closed configuration and when the headset is retained in the recess, portions of the first and second housing portions and a portion of the headset form an external surface of the portable electronic device.

13. The portable electronic device of claim 3, wherein the one of the first and second housing portions comprises a second recess for removably receiving and retaining a wireless headset.

14. The portable electronic device of claim 1, wherein the first housing portion and the second housing portion are pivotably connected.

15. The portable electronic device of claim 1, wherein the accessory device comprises a strap having a first end having a stylus and a second end extending from one of the first and second housing portions, wherein the recess is structured to receive the stylus, and wherein the stylus is retained in the recess when the first and second housing portions are in the closed configuration such that the strap is usable as a carrying strap for the portable electronic device.

16. A portable electronic device comprising:
a cable for electrically coupling the portable electronic device to another electronic device, the cable comprising:
a first end physically and electrically connected to the portable electronic device; and
a second end comprising both a stylus and a connector for electrically coupling the cable to the other electronic device.

17. The portable electronic device of claim 16, wherein the second end comprises:
a connector for electrically coupling the cable to the other electronic device; and
a generally pointed stylus portion for use as a stylus.

18. The portable electronic device of claim 17, wherein the stylus portion of the second end is structured to be moveable between a first position, where the stylus portion covers the connector and a second position where the connector is exposed.

19. The portable electronic device of claim 18, wherein the stylus portion defines a recess for receiving at least a portion of the connector when the stylus portion is in the first position.

20. The portable electronic device of claim 19, wherein the stylus portion is hingedly connected to the second end of the cable such that the stylus portion is movable from the first position to the second position while remaining connected to the second end of the cable when in both the first and second positions.

21. The portable electronic device of claim 20, wherein the second end is structured so that the stylus portion is moveable from the first position to the second position by sliding the stylus portion along an axis defined by the connector and in a direction generally away from the connector in order to remove the connector from the recess in the stylus portion, and rotating the stylus portion in order to uncover the connector.

22. The portable electronic device of claim 21 wherein the portion of the second end of the cable containing the connector comprises two pins oppositely disposed on each side of the connector, and wherein the stylus portion comprises two oppositely disposed tracks that are structured to engage the two pins and allow the stylus portion to slide and rotate relative to the connector.

23. The portable electronic device of claim 16, wherein the second end of the cable is removably attachable to a portion of the portable electronic device so that the cable generally forms a loop structured to be used as a carrying strap.

24. The portable electronic device of claim 16, wherein the cable is configured to be connectable to another electronic device for transferring data and power between the portable electronic device and the other electronic device.

24. The portable electronic device of claim 23, wherein the connector comprises a Universal Serial Bus type connector.

25. The portable electronic device of claim 15, wherein the portable electronic device comprises a touch screen display, and wherein the stylus is configured to enter data by touching the display or by moving the stylus over the display.

26. A method of using an electronic cable as a carrying strap for a portable electronic device, the cable having a first end extending from the portable electronic device and a second end having an electrical connector, the method comprising:
moving a first housing portion of the portable electronic device relative to a second housing portion of the portable electronic device from a first position to a second position exposing a recess in the first housing portion;
placing the electrical connector into the recess; and
rotating the first housing portion back to the first position.

27. The method of claim 26, further comprising:
moving the first housing portion relative to the second housing portion from the first position to the second position exposing the electrical connector in the first housing portion;
removing the electrical connector from the recess; and
coupling the electrical connector to a corresponding connector in another electronic device.

28. The method of claim 27, further comprising:
exposing the electrical connector by moving a stylus portion.

29. The method of claim 26, wherein the moving step further comprises pivoting the first housing portion relative to the second housing portion about a pivot point.

30. A method of converting a stylus to an electrical connector, the stylus comprising a stylus portion coupled to an end of an electrical cable and covering an end of the electrical connector, the method comprising:
rotating the stylus portion to one side of the electrical connector such that the end of the electrical connector is capable of connecting to a compatible connector.

31. The method of claim 30, further comprising:
sliding the stylus portion in a direction away from the end of the cable, thereby, exposing the end of the electrical connector.

32. The method of claim 31, wherein the sliding of the stylus portion is prior to the rotating of the stylus portion.

33. The method of claim 30, further comprising:
coupling the electrical connector to a corresponding connector in another electronic device.
